(19) United States
(12) Patent Application Publication
(10) Pub. No.: US 2010/0183070 A1
(43) Pub. Date: Jul. 22, 2010

(54) METHOD AND APPARATUS FOR IMPROVED VIDEO ENCODING USING REGION OF INTEREST (ROI) INFORMATION

(76) Inventors: Xiaoan Lu, Princeton, NJ (US); Zhen Li, Burbank, CA (US); Cristina Gomila, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/733,149

(22) PCT Filed: Aug. 12, 2008
(86) PCT No.: PCT/US08/09627

§ 371 Date: Mar. 19, 2010

Related U.S. Application Data
(60) Provisional application No. 60/956,098, filed on Aug. 15, 2007.

(51) Int. Cl. H04N 7/26

(52) U.S. Cl. 375/240.08; 375/E07.076

(57) ABSTRACT

A method and apparatus are provided for improved video encoding using region of interest information. The apparatus includes an encoder for encoding a plurality of regions of a picture by determining, using region of interest detection, a respective probability that each of the plurality of regions belong to a region of interest, and adaptively controlling a respective quality of each of the plurality of regions based on a value of the respective probability.

### CROSS-REFERENCE TO RELATED APPLICATIONS

This application claims the benefit of U.S. Provisional Application Ser. No. 60/956,098, filed 15 Aug. 2007, which is incorporated by reference herein in its entirety.

### TECHNICAL FIELD

The present principles relate generally to video encoding and, more particularly, to a method and apparatus for improved video encoding using region of interest (ROI) information.

### BACKGROUND

Some regions of interest in a picture are more important to human eyes than other regions. For example, in the case of a picture in a videophone application, a region corresponding to skin tone would be considered to be important with respect to other regions and, hence, would correspond to a region of interest. Obtaining high perceptual quality in these regions is desired in order to obtain an overall good perceptual quality in corresponding displayed pictures. In the case of video compression applications, the displayed pictures are the decoded pictures. To allow different perceptual quality within a picture, video coding standards such as, for example, the International Organization for Standardization/International Electrotechnical Commission (ISO/IEC) Moving Picture Experts Group-2 (MPEG-2) standard and the ISO/IEC Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), provide mechanisms to obtain higher quality in certain regions than others. To address the importance of these regions, one should first detect these regions, and then target a higher perceptual quality in these regions. In the case of video compression algorithms, higher perceptual quality can be obtained by allocating more bits to retain more details.

A typical application using such information often assumes that the detection of a region of interest (ROI) is accurate and assigns different levels of perceptual quality accordingly. This assumption often does not hold in a practical application, either because the detection algorithms cannot adapt to the contents or because computation complexity constraints prevent more complicated and powerful algorithms from being used for the application.

There are various factors of the human vision system (HVS) to consider when applying region of interest detection results to improve the perceptual quality. Some factors are related to the optical property of the eyes and the retina structure. Such factors include color, spatial masking, temporal masking, and motion tracking property of the human vision system. Other factors reflect human cognitive processing, such as object/pattern recognition based on knowledge and experience. One example of human cognitive factors is that the presence of human skin tones typically attracts more visual attention than other regions in the picture.

In conversational videophone applications, the face is often given the most significant part of the visual attention. In one prior art approach, the face is first detected in a picture and is then assigned higher perceptual quality. The higher perceptual quality is obtained through the video codec Test Model, Near-Term, version 8 (TMN8) rate control algorithm that assigns a finer quantization parameter to the skin region. In another prior art approach, a picture is also segmented into macroblocks (MBs) that belong to the following regions: the foreground (FG) including faces; and the background (BG). The other prior art approach then assigns a finer quantization step size Q_{f} to the foreground region and a coarser Q_{b} to the background in a video encoder as follows:

$$quantization step size = \{ \begin{matrix}{Q}_{f} , & if current MB belongs to FG \\ {Q}_{b} , & if current MB belongs to BG .\end{matrix} \qquad ( 1 )$$

Both prior art approaches obtain higher perceptual quality at the given bitrate by allowing the skin regions to be encoded at a higher quality.

In both prior art approaches, the schemes are certainly helpful in improving the decoded picture quality at a given bitrate for videophone applications where skin region segmentation algorithms have been well developed and usually provide accurate results. However, for general contents from non-videoconference applications, skin segmentation is more complicated and the detection accuracy ratio is much lower. The detection inaccuracy occurs when a skin region is not detected as skin (false negative detection), or when a non-skin region is detected as skin (false positive detection).

In the existence of false positive detection, the video encoder assigns higher perceptual quality to the false skin region and leaves fewer bits to other regions in the picture. Hence, when false positive detection occurs, applying the above approaches may hurt the perceptual quality. In the case of false negative detection, the skin regions are treated the same as other regions and are assigned the same perceptual quality. This prohibits the application from delivering higher quality to the location that attracts more attention.

One solution to obtain high perceptual quality while using the skin detection result as the region of interest information is to improve the skin detection accuracy. This will often require higher computation complexity that is not always available in a practical application.

The typical usage of region of interest information will now be described. A typical region of interest detection algorithm segments the picture into the following two categories of regions, (1) the ROI and (2) the non-ROI, based on a threshold T, applied to a feature p.

In the case of skin detection, the feature may be the probability that a macroblock (MB) belongs to the skin region, and the detection function is defined as follows:

$$MB ∈ \{ \begin{matrix}ROI , & if p > T \\ non ROI , & otherwise\end{matrix} \qquad ( 2 )$$

The application then assigns perceptual quality according to the binary segmentation results. Turning to FIG. 1, a binary region of interest decision for a one-dimensional feature space is indicated generally by the reference numeral 100.

More bits are assigned to the region of interest by using a finer quantization step size and fewer bits are assigned to the non-region-of-interest by using a coarser quantization step size. Hence, the region of interest has higher quality than the non-region-of-interest and the overall picture has a higher perceptual quality.

Turning to FIG. 2, a method for quantization step size assignment in a typical video encoder that uses regions of interest information is indicated generally by the reference numeral 200.

The method 200 includes a start block 205 that passes control to a function block 210. The function block 210 performs region of interest (ROI) detection, and passes control to a function 215. The function block 215 performs an encoding setup, and passes control to a loop limit block 220. The loop limit block 220 performs a first loop over each frame of an input video sequence using a variable i equal to 1, . . . , number (#) of frames, and passes control to a loop limit block 225. The loop limit block 225 performs a second loop over each macroblock in each frame using a variable j equal to 1, . . . , number (#) of macroblocks in frame i, and passes control to a decision block 230. The decision block 230 determines whether or not the current macroblock belongs to the region of interest (ROI). If so, then control is passed to a function block 235. Otherwise, control is passed to a function block 240.

The function block 235 assigns a finer quantization step size, and passes control to a loop limit block 245. The loop limit block 245 ends the second loop, and passes control to a loop limit block 250. The loop limit block 250 ends the first loop, and passes control to an end block 299.

With respect to the encoding step referred to with respect to function block 215, such set may be performed with the aid of an operator. Moreover, the encoder setup may involve the setup of the target bit-rate as well as the specification of any set of parameters involved in the encoding process.

It is to be appreciated that the method 200 may be a single or multi-pass encoding method, and in most cases it will comply with an existing video coding standard and/or recommendation including, but not limited to, MPEG-2, and MPEG-4 AVC. When a multi-pass approach is used, the ROI information can be used in one or more passes of the encoder.

In the method 200, a finer quantization step size is applied when the current macroblock being evaluated belongs to a ROI, resulting in more bits and higher perceptual quality. Otherwise, a coarser quantization step size is applied when the macroblock does not belong to the ROI, resulting in fewer bits and lower perceptual quality.

The applications following the workflow illustrated in FIG. 2 assume the region of interest detection is accurate and assign perceptual quality accordingly. The performance of such applications heavily depends on the region of interest detection results. Considering a region in a picture that is encoded using region of interest information, we get the following four possible combinations:
Case 1: a ROI is detected as a ROI (accurate);
Case 2: a ROI is detected as a non-ROI (false negative);
Case 3: a non-ROI is detected as a non-ROI (accurate);
Case 4: a non-ROI is detected as a ROI (false positive).

When Case 2 (false negative detection) occurs, the applications spend too few bits in the region of interest, restricting the applications from providing a high perceptual quality. When Case 4 (false positive detection) occurs, the applications waste too many bits in non-ROI regions.

Turning to FIG. 3, an apparatus for encoding video data into a resultant bitstream using rate control in accordance with the prior art is indicated generally by the reference numeral 300.

The apparatus 300 includes a quantization step size weighting module 305 having an output in signal communication with a first input of a rate controller 310. An output of the rate controller 310 is connected in signal communication with a first input of a video encoder 320.

An input of the quantization step size weighting module 305 is available as an input of the apparatus 300, for receiving region of interest (ROI) information. A second input of the video encoder 320 is available as an input of the apparatus 300, for receiving an input video source (e.g., a video sequence). A second input of the rate controller 310 is available as an input of the apparatus 300, for receiving rate constraints. An output of the video encoder 320 is available as an output of the apparatus 300, for outputting a bitstream.

The apparatus 300 is capable of implementing the quantization step assignment described with respect to function blocks 235 and 240 of the method 200 of FIG. 2.

### SUMMARY

These and other drawbacks and disadvantages of the prior art are addressed by the present principles, which are directed to a method and apparatus for improved video encoding using region of interest (ROI) information.

According to an aspect of the present principles, there is provided an apparatus. The apparatus includes an encoder for encoding a plurality of regions of a picture by determining, using region of interest detection, a respective probability that each of the plurality of regions belong to a region of interest, and adaptively controlling a respective quality of each of the plurality of regions based on a value of the respective probability.

According to another aspect of the present principles, there is provided a method. The method includes encoding a plurality of regions of a picture by determining, using region of interest detection, a respective probability that each of the plurality of regions belong to a region of interest, and adaptively controlling a respective quality of each of the plurality of regions based on a value of the respective probability.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing a binary region of interest decision for a one-dimensional feature space, in accordance with the prior art;

FIG. 2 is a flow diagram showing a method for quantization step size assignment in a typical video encoder that uses regions of interest information, in accordance with the prior art;

FIG. 3 is a block diagram showing an apparatus for encoding video data into a resultant bitstream using rate control in accordance with the prior art;

FIG. 4 is a block diagram showing an exemplary video encoder, in accordance with an embodiment of the present principles;

FIG. 5 is a diagram showing the linear relationship between assigned quality and region of interest probability, in accordance with an embodiment of the present principles;

FIG. 6 is a flow diagram showing an exemplary method for encoding a video sequence, using the probability of a macroblock being in a region of interest to control the corresponding perceptual quality, in accordance with an embodiment of the present principles;

FIG. 7 is a diagram showing the relationship between assigned quality and region of interest probability for region of interest probability intervals, in accordance with an embodiment of the present principles;

FIG. 8 is a flow diagram showing an exemplary method for encoding a video sequence using multiple levels of quality based on a probability of a macroblock being in a region of interest, in accordance with an embodiment of the present principles; and

FIG. 9 is a block diagram showing an apparatus for encoding video data into a resultant bitstream using rate control in accordance with an embodiment of the present principles.

### DETAILED DESCRIPTION

The present principles are directed to a method and apparatus for improved video encoding using region of interest (ROI) information.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, it is to be appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles. For example, the present principles may also be applied, but are not limited to, the MPEG-2 Standard and the Society of Motion Picture and Television Engineers (SMPTE) Video Codec-1 (VC-1) Standard.

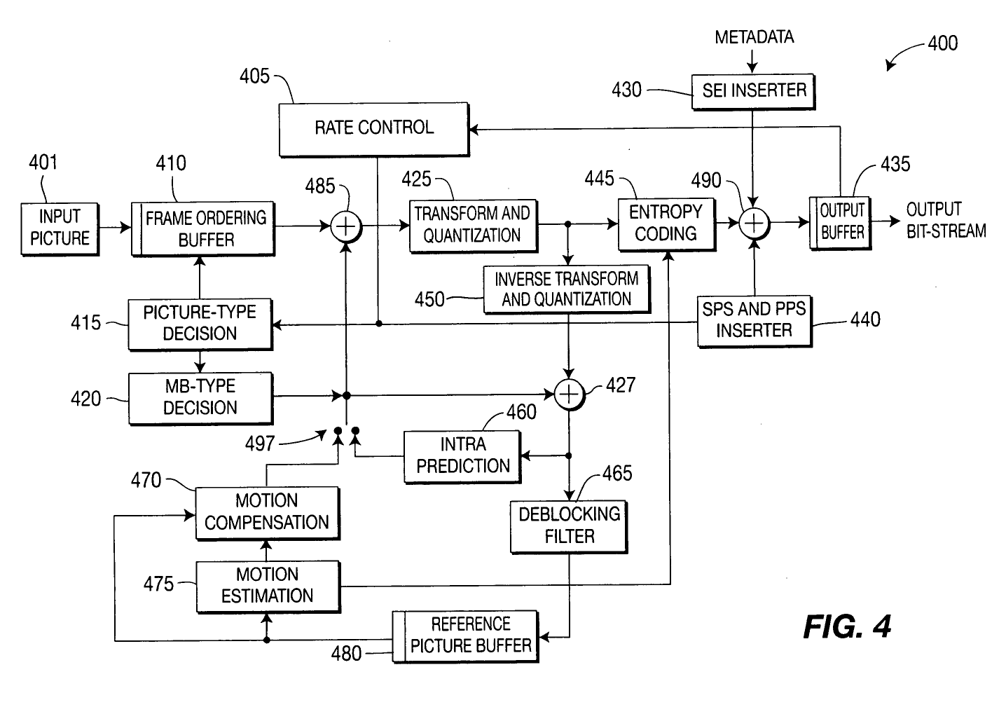

Turning to FIG. 4, an exemplary video encoder is indicated generally by the reference numeral 400.

The encoder 400 includes a frame ordering buffer 410 having an output connected in signal communication with a first non-inverting input of a combiner 485. An output of the combiner 485 is connected in signal communication with an input of a transformer and quantizer 425. An output of the transformer and quantizer 425 is connected in signal communication with a first input of an entropy coder 445 and an input of an inverse transformer and quantizer 450. An output of the entropy coder 445 is connected in signal communication with a first non-inverting input of a combiner 490. An output of the combiner is connected in signal communication with an input of an output buffer 435. A first output of the output buffer 435 is connected in signal communication with an input of a rate controller 405.

An output of a Supplemental Enhancement Information (SEI) inserter 430 is connected in signal communication with a second input of the combiner 490.

An output of the inverse transformer and quantizer 450 is connected in signal communication with a first non-inverting input of a combiner 427. An output of the combiner 427 is connected in signal communication with an input of an intra predictor 460 and an input of a deblocking filter 465.

An output of the deblocking filter 465 is connected in signal communication with an input of a reference picture buffer 480. An output of the reference picture buffer 480 is connected in signal communication with an input of a motion estimator 475 and a first input of a motion compensator 470.

A first output of the motion estimator 475 is connected in signal communication with a second input of the motion compensator 470. A second output of the motion estimator 475 is connected in signal communication with a second input of the entropy coder 445.

An output of the motion compensator 470 is connected in signal communication with a first input of a switch 497. An output of the intra predictor 460 is connected in signal communication with a second input of the switch 497. An output of a macroblock-type decision module 420 is connected in signal communication with a third input of the switch 497. An output of the switch 497 is connected in signal communication with a second non-inverting input of the combiner 485 and a second non-inverting input of the combiner 427.

An output of the rate controller 405 is connected in signal communication with a first input of a picture-type decision module 415, and an input of a sequence parameter set (SPS) and picture parameter set (PPS) inserter 440. An output of the SPS and PPS inserter 440 is connected in signal communication with a third input of the combiner 490.

A first output of the picture-type decision module 415 is connected in signal communication with an input of the macroblock-type decision module 420. A second output of the picture-type decision module 415 is connected in signal communication with a second input of the frame ordering buffer 410.

A first input of the frame ordering buffer 410 is available as an input to the encoder 400, for receiving an input picture 401. A first output of the output buffer 435 is available as an output of the encoder 400, for outputting a bitstream.

As noted above, the present principles are directed to a method and apparatus for improved video encoding using region of interest (ROI) information. Some regions of interest, such as skin tones in a picture of a videophone application, are more important to human eyes than other regions. In an embodiment, we rank the importance of different regions by taking into account the inaccuracy of the region of interest detection results. This is done by accepting the probability that a region belongs to a region of interest as the input to assign the perceptual quality. The present principles consider the fact that the region of interest detection is often inaccurate and provide a robust scheme to provide higher perceptual quality for applications that use region of interest information. The benefit is an improvement in the overall perceptual quality.

Thus, in accordance with the present principles, we assign the perceptual quality of different regions in a picture based on the inaccurate region of interest detection results and other auxiliary information. Using skin tone as an example of a region of interest, we explain the use of region of interest information in accordance with the present principles. Of course, it is to be appreciated that the present principles are not limited to solely skin tone as a region of interest and, thus, other types of regions of interest are also contemplated for use in accordance with the present principles, while maintaining the spirit of the present principles.

In an embodiment, a method in accordance with the present principles considers the fact that region of interest detection is often inaccurate and provides a robust scheme to obtain a higher perceptual quality for a video encoder that uses region of interest information. This is done by accepting a statistical region of interest detection result, i.e., the probability that a region belongs to the region of interest.

The region of interest is often detected based on the priori knowledge and experience. Which regions should be detected as the regions of interest also depends on the applications. For example, in a videophone application, facial regions are commonly considered as regions of interest. In sports events such as, for example, football, the ball is commonly considered to be a region of interest. The features of the possible regions of interest such as, for example, color, shape, and so forth, are usually considered when detecting the regions of interest. When the features are not appropriately identified, it is very possible that the region of interest will not be detected accurately. For example, when the facial regions are taken as the regions of interest, since human skin color tends to occur in a very limited range in a color space, the color component of human skin needs to be modelled to detect the regions of interest. When the model cannot adapt to the contents and is not accurate, both positive false detection and negative false detection can occur.

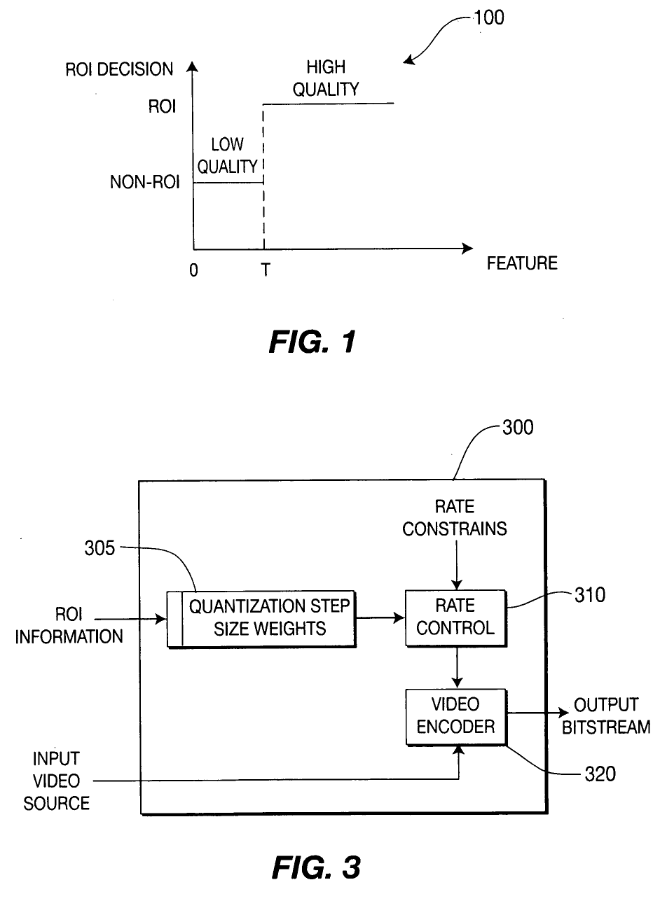

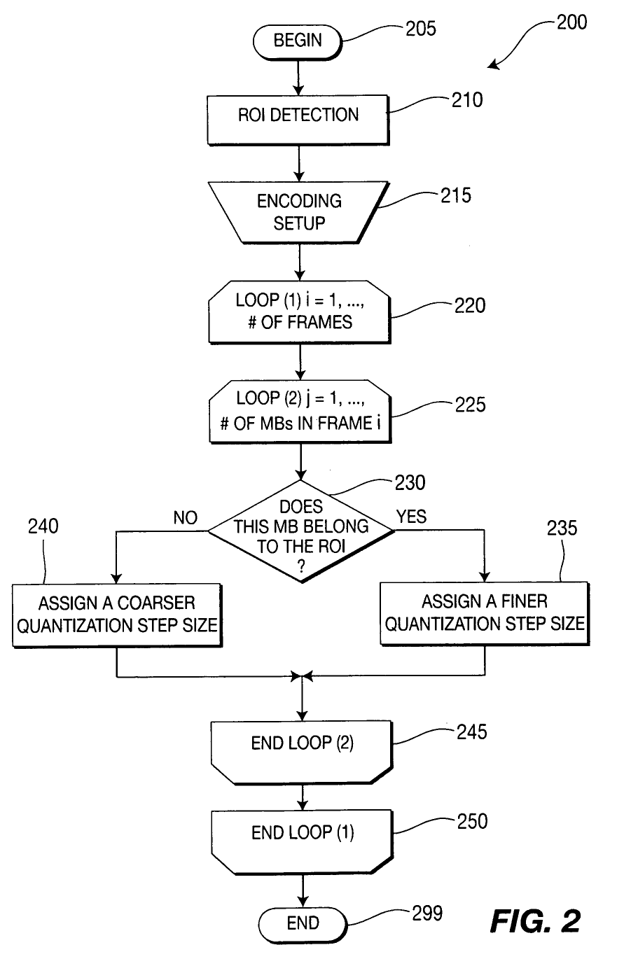

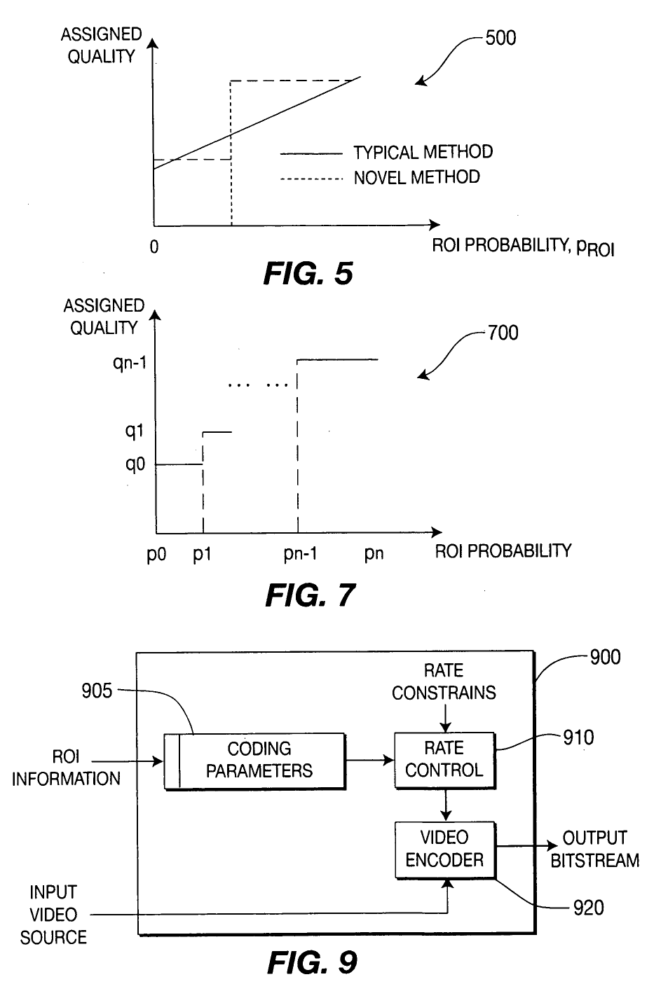

In a typical video encoder that uses region of interest information, a picture is first divided into a region of interest and non-region of interest (non-ROI), and then the encoder controls the quality of the macroblocks in a picture depending on whether or not a particular macroblock being evaluated belongs to the region of interest. The prior art uses a binary result (i.e., yes or no, regarding whether a particular region under evaluation corresponds to a region of interest) for the region of interest detection, as shown and described with respect to FIG. 1. The prior art does not consider or use a probability value in controlling the quality. In accordance with an embodiment, an approach is provided that allows the encoder to accept the probability of a region being a region of interest, denoted as p_{ROI}(MB), as an input to control the quality. As a general rule, the higher the probability of a macroblock being in a region of interest, the higher the quality assigned by the encoder. This is illustrated in FIG. 5. Turning to FIG. 5, the linear relationship between assigned quality and region of interest probability is indicated generally by the reference numeral 500. In a general application, this relation can be extended to other monotonically increasing forms.

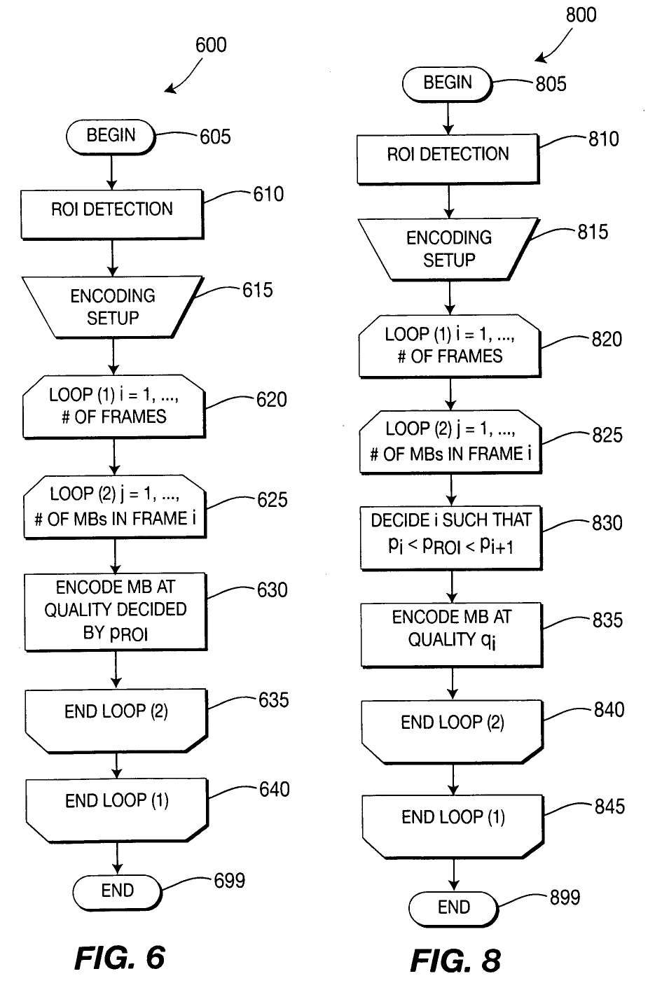

Turning to FIG. 6, an exemplary method for encoding a video sequence using the probability of a macroblock being in a region of interest to control the corresponding perceptual quality is indicated generally by the reference numeral 600. In particular, the method 600 accepts a variable p_{ROI}(MB) as an input to control the perceptual quality, and decides at what quality a current macroblock under consideration should be encoded based on p_{ROI}(MB).

The method 600 includes a start block 605 that passes control to a function block 610. The function block 610 performs region of interest (ROI) detection, and passes control to a function 615. The function block 615 performs an encoding setup, and passes control to a loop limit block 620. The loop limit block 620 performs a first loop over each frame of an input video sequence using a variable i equal to 1, . . . , number (#) of frames, and passes control to a loop limit block 625. The loop limit block 625 performs a second loop over each macroblock in each frame using a variable j equal to 1, . . . , number (#) of macroblocks in frame i, and passes control to a function 630. The function block 630 encodes the macroblock at a quality decided based upon p_{ROI}, and passes control to a loop limit block 635. The loop limit block 635 ends the second loop, and passes control to a loop limit block 640. The loop limit block 640 ends the first loop, and passes control to an end block 699

With respect to function block 630, it is to be appreciated that the perceptual quality can be measured by subjective quality assessments or objective perceptual quality metrics. Subjective quality assessments are carefully designed procedures intended to determine the average opinion of human viewers to a specific set of video sequences for a given application. Results of such tests are valuable in basic system design and benchmark evaluations. Subjective quality assessments however are time-consuming since human viewers are required. Objective quality metrics measure the quality automatically and are intended for use in a broad set of applications. Examples of objective quality metrics include, but are not limited to, peak signal-to-noise ratio (PSNR), just noticeable distortion (JND), and structural similarity index metric (SSIM), and so forth.

In an embodiment, the video encoder decides the target quality metric for each macroblock based on p_{ROI}(MB). The exact relation between the target quality metric and p_{ROI}(MB) is determined, by a user or by the encoder, in consideration of obtaining an overall high perceptual quality. A set of coding parameters are then used to encode a macroblock to meet the target quality metric. The coding parameters include, but are not limited to, coding modes, block sizes, and quantization parameters that, in turn, include, but are not limited to, quantization step sizes, deadzoning parameters, and quantization matrices.

The quality improvement of this new approach comes largely from the macroblocks whose p_{ROI}(MB) are around the threshold that is used in region of interest detection for a classical encoder. The decision of the threshold is usually the key problem in a region of interest detection algorithm and any inaccuracy will cause false detection. In the case when the threshold is too low (as compared to a more accurate threshold), false positive detection occurs and the video encoder assigns more bits to the false region of interest and leaves fewer bits for other regions in the picture. In the case when the threshold too high (as compared to a more accurate threshold), false negative detection occurs and the regions of interest are treated the same as other regions. Under both circumstances, the inaccurate threshold results in inaccurate region of interest detection that prohibits the application from delivering higher quality to the location that attracts more attention. In accordance with an embodiment of the present principles, we assign the bits based on p_{ROI}(MB). Therefore, we avoid assigning too many bits or too few bits to the macroblocks whose p_{ROI}(MB) are around the threshold.

In the above described embodiment, we disclose an encoding workflow that continuously adjusts quality to p_{ROI}(MB). One variation of this embodiment is to let the macroblocks encode at finite levels of quality, depending on which interval of p_{POI}(MB) to which the macroblocks belong. Turning to FIG. 7, the relationship between assigned quality and region of interest probability for region of interest probability intervals is indicated generally by the reference numeral 700. In FIG. 7, when pᵢ<p_{ROI}(MB)<pᵢ₊₁, i=0, . . . , n−1, the macroblock will be encoded at the perceptual quality indicated by a quality metric qᵢ. The classical encoder that uses a binary region of interest detection result is a special case of method 800, in particular, at n=2.

Turning to FIG. 8, an exemplary method for encoding a video sequence using multiple levels of quality based on a probability of a macroblock being in a region of interest is indicated generally by the reference numeral 800.

The method 800 includes a start block 805 that passes control to a function block 810. The function block 810 performs region of interest (ROI) detection, and passes control to a function 815. The function block 815 performs an encoding setup, and passes control to a loop limit block 820. The loop limit block 820 performs a first loop over each frame of an input video sequence using a variable i equal to 1, . . . , number (#) of frames, and passes control to a loop limit block 825. The loop limit block 825 performs a second loop over each macroblock in each frame using a variable j equal to 1, . . . , number (#) of macroblocks in frame i, and passes control to a function 830. The function block 830 determines a perceptual quality for a current macroblock such that pᵢ<p_{ROI}<Pᵢ₊₁, and passes control to a function block 835. The function block 835 encodes the macroblock at quality qi, and passes control to a loop limit block 840. The loop limit block 840 ends the second loop, and passes control to a loop limit block 845. The loop limit block 845 ends the first loop, and passes control to an end block 899.

It is to be appreciated that method 800 is a variation of method 600 shown and described with respect to FIG. 6. When encoding a current macroblock, the encoder first reads the probability that the current macroblock belongs to the ROI p_{ROI}(MB) and decides to which interval the current macroblock belongs. After it is determined that p_{ROI}(MB) is within two adjacent thresholds pᵢ and pᵢ₊₁, the current macroblock will be encoded at quality qᵢ. The advantage of this variation is that the encoder is simplified by encoding the macroblocks at finite levels of quality indicated by the quality metrics.

Turning to FIG. 9, an apparatus for encoding video data into a resultant bitstream using rate control in accordance with an embodiment of the present principles is indicated generally by the reference numeral 900.

The apparatus 900 includes a coding parameters module 905 having an output in signal communication with a first input of a rate controller 910. An output of the rate controller 910 is connected in signal communication with a first input of a video encoder 920.

An input of the coding parameters module 905 is available as an input of the apparatus 900, for receiving region of interest (ROI) information. A second input of the video encoder 920 is available as an input of the apparatus 900, for receiving an input video source (e.g., a video sequence). A second input of the rate controller 910 is available as an input of the apparatus 900, for receiving rate constraints. An output of the video encoder 920 is available as an output of the apparatus 900, for outputting a bitstream.

The apparatus 900 is capable of performing the steps described with respect to function blocks 630 and 835 of the methods 600 and 800, respectively, of FIGS. 6 and 8, respectively.

A description will now be given of some of the many attendant advantages/features of the present invention, some of which have been mentioned above. For example, one advantage/feature is an apparatus having an encoder for encoding a plurality of regions of a picture by determining, using region of interest detection, a respective probability that each of the plurality of regions belong to a region of interest, and adaptively controlling a respective quality of each of the plurality of regions based on a value of the respective probability.

Another advantage/feature is the apparatus having the encoder as described above, wherein the region of interest detection is based on at least one feature, the at least one feature being skin tone information.

Yet another advantage/feature is the apparatus having the encoder as described above, wherein any of the plurality of regions determined to belong to the region of interest are encoded using a continuous level of quality.

Still another advantage/feature is the apparatus having the encoder as described above, wherein any of the plurality of regions determined to belong to the region of interest are encoded using finite levels of quality.

Moreover, another advantage/feature is the apparatus having the encoder as described above, wherein the encoder encodes the plurality of regions into a bitstream compliant with the International Organization for Standardization/International Electrotechnical Commission Moving Picture Experts Group-4 Part 10 Advanced Video Coding standard/International Telecommunication Union, Telecommunication Sector H.264 recommendation.

Further, another advantage/feature is the apparatus having the encoder as described above, wherein the encoder encodes the plurality of regions into a bitstream compliant with the Society of Motion Picture and Television Engineers Video Codec-1 Standard.

Also, another advantage/feature is the apparatus having the encoder as described above, wherein the respective quality of any of the plurality of regions determined to belong to the region of interest is respectively controlled by adjusting coding parameters.

Additionally, another advantage/feature is the apparatus having the encoder as described above, wherein the coding parameters include quantization parameters.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited'to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding a plurality of regions of a picture by determining, using region of interest detection, a respective probability that each of the plurality of regions belong to a region of interest, and adaptively controlling a respective quality of each of the plurality of regions based on a value of the respective probability.

2. The apparatus of claim 1, wherein the region of interest detection is based on at least one feature, the at least one feature being skin tone information.

3. The apparatus of claim 1, wherein any of the plurality of regions determined to belong to the region of interest are encoded using a continuous level of quality.

4. The apparatus of claim 1, wherein any of the plurality of regions determined to belong to the region of interest are encoded using finite levels of quality.

5. The apparatus of claim 1, wherein said encoder encodes the plurality of regions into a bitstream compliant with the International Organization for Standardization/International Electrotechnical Commission Moving Picture Experts Group-4 Part 10 Advanced Video Coding standard/International Telecommunication Union, Telecommunication Sector H.264 recommendation.

6. The apparatus of claim 1, wherein said encoder encodes the plurality of regions into a bitstream compliant with the Society of Motion Picture and Television Engineers Video Codec-1 Standard.

7. The apparatus of claim 1, wherein the respective quality of any of the plurality of regions determined to belong to the region of interest is respectively controlled by adjusting coding parameters.

8. The apparatus of claim 7, wherein the coding parameters include quantization parameters.

9. A method, comprising:
encoding a plurality of regions of a picture by determining, using region of interest detection, a respective probability that each of the plurality of regions belong to a region of interest, and adaptively controlling a respective quality of each of the plurality of regions based on a value of the respective probability.

10. The method of claim 9, wherein the region of interest detection is based on at least one feature, the at least one feature being skin tone information.

11. The method of claim 9, wherein any of the plurality of regions determined to belong to the region of interest are encoded using a continuous level of quality.

12. The method of claim 9, wherein any of the plurality of regions determined to belong to the region of interest are encoded using finite levels of quality.

13. The method of claim 9, wherein said encoding step encodes the plurality of regions into a bitstream compliant with the International Organization for Standardization/International Electrotechnical Commission Moving Picture Experts Group-4 Part 10 Advanced Video Coding standard/International Telecommunication Union, Telecommunication Sector H.264 recommendation.

14. The method of claim 9, wherein said encoding step encodes the plurality of regions into a bitstream compliant with the Society of Motion Picture and Television Engineers Video Codec-1 Standard.

15. The method of claim 9, wherein the respective quality of any of the plurality of regions determined to belong to the region of interest is respectively controlled by adjusting coding parameters.

16. The method of claim 15, wherein the coding parameters include quantization parameters.
